(19) United States
(12) Patent Application Publication
(10) Pub. No.: US 2020/0193323 A1
(43) Pub. Date: Jun. 18, 2020

(54) METHOD AND SYSTEM FOR HYPERPARAMETER AND ALGORITHM SELECTION FOR MIXED INTEGER LINEAR PROGRAMMING PROBLEMS USING REPRESENTATION LEARNING

(71) Applicant: NEC Laboratories Europe GmbH, Heidelberg (DE)

(72) Inventors: Francesco Alesiani, Heidelberg (DE); Brandon Malone, Dossenheim (DE); Mathias Niepert, Heidelberg (DE)

(21) Appl. No.: 16/223,155

(22) Filed: Dec. 18, 2018

(51) Int. Cl. G06N 20/00; G06K 9/62; G06N 7/00; B25J 9/16; G06F 16/901

(52) U.S. Cl. CPC G06N 20/00; G06K 9/6223; G06F 16/9024; B25J 9/1661; G06N 7/00

(57) ABSTRACT

A method for hyperparameter selection (HPS) and algorithm selection (AS) for mixed integer linear programming (MILP) problems includes collecting MILP problems and performances of associated solvers for optimizing the MILP problems. Each of the MILP problems is mapped into a graph having nodes each comprising one of the variables and constraints of the MILP problems. Raw features of the nodes of the graphs are generated. For each of the graphs, a representation of the nodes of the graphs is learned using the raw features which is global to the MILP problems using the raw features. A machine learning model is trained using the learned representations. The trained learning model is used to select one of the solvers for a new MILP problem.

### FIELD

The present invention relates to hyperparameter selection (HPS) and algorithm selection (AS) for mixed integer linear programming (MILP) problems. MILP is also referred to as constrained integer programming (CIP).

### BACKGROUND

MILP problems exist in a variety of industries. In most cases, the MILP problems are non-deterministic polynomial-time (NP) hard. Despite this, general solvers have been developed which still find optimal solutions to these problems. The solvers can be implemented by software and in each case comprise one or more algorithms for arriving at a solution to the MILP problem. These algorithms each comprise a set of sophisticated heuristics used to compute the solutions, and each of the heuristics have multiple parameters such that the full software or algorithm is controlled by a plethora of hyperparameters. For each of the algorithms there can be numerous possible configurations of these hyperparameters, and the output of the solvers can be a set of configurations. Due to the unknown difficulty of any particular MILP problem, it is, in general, unknown how long a particular solver with a particular configuration of hyperparameters will take to optimize the problem. Further, the solvers are not able to determine solutions for specific time and/or accuracy requirements.

Since MILP problems are generally large, generic problems, and there may be a number of different ways to solve the same problem, there may be multiple algorithms, solvers or software selecting the best solver and its hyperparameters requires testing many configurations in a brute force approach, which is costly in terms of time and compute power. Moreover, such an approach cannot be used for applications which need real- or near real-time execution.

Further, as recognized by Eggensperger, K. et al., “Neural Networks for Predicting Algorithm Runtime Distributions,” International Joint Conference on Artificial Intelligence, pp. 1442-1448, arxiv.org/abs/1709.07615 (May 9, 2018), which is hereby incorporated by reference herein, the algorithms include elements of stochasticity that can lead to unpredictably variable run-times, even for a fixed problem instance. Run-time distributions for the algorithms are even further varied by the use of randomization.

Hutter, F., et al., “Algorithm runtime prediction: Methods and evaluation,” Artificial Intelligence 206, pp. 79-111 (2014), which is hereby incorporated by reference herein, describe AS for MILP problems in different applications and the use of a model to predict algorithm run-times.

U.S. Patent Application Publication No. 2014/0358831, which is hereby incorporated by reference herein, describes using a Bayesian approach to optimize hyperparameters. In Bayesian optimization, an internal model of expected performances is used and updated as different hyperparameter configurations are iteratively tested. The algorithms of the solvers measure the performance of the different hyperparameter configurations. Other approaches for HPS would be to generate a grid (regular or unregular) and test the different configurations, or to randomly select hyperparameter configurations sequentially or in one run. According to the sequential method, different hyperparameters can be continued to be selected and tested until performance degrades. According to a batch test, a maximum number of hyperparameter configurations can all be tested to select the one with the best performance.

### SUMMARY

In an embodiment, the present invention provides a method for hyperparameter selection (HPS) and algorithm selection (AS) for mixed integer linear programming (MILP) problems. MILP problems and performances of associated solvers for optimizing the MILP problems, for example, being determined offline, are collected. Each of the MILP problems is mapped into a graph having nodes each comprising one of the variables and constraints of the MILP problems. Raw features of the nodes of the graphs are generated. For each of the graphs, a representation of the nodes of the graphs is learned using the raw features which is global to the MILP problems using the raw features. A machine learning model is trained using the learned representations. The trained learning model is used to select one of the solvers for a new MILP problem.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic overview of training and deployment phases of a method according to an embodiment of the present invention;

FIG. 2 is an example of a bipartite graph mapping a MILP problem into graph for representation learning according to an embodiment of the present invention;

FIG. 3 is a flowchart illustrating the representation learning according to an embodiment of the present invention;

FIG. 4 is a flowchart illustrating the representation learning according to an embodiment of the present invention; and

FIG. 5 is a graph showing the performance of the method according to the present invention in comparison to other methods.

### DETAILED DESCRIPTION

Embodiments of the present invention provide a method to off-load optimal HPS and AS for MILP problems by leveraging on the construction of representation learning on a graph. The method is able to provide a close to optimal configuration with a computational speed an order of magnitude faster than existing tools for HPS and AS, and with a gain of 8% in a tested dataset with respect to state of the art regression approaches. Further, the method allows for more advanced manipulation of MILP problems.

The inventors recognize that prediction of runtime or performance of complex algorithms or multiple algorithms can lead to significant improvements in the performance of technical systems in real time and on unseen instances. Hyperparameter selection and algorithm selection based on the predicted performance heavily depends on the absolute error, but also on the relative error (or ranking) of the algorithms and hyperparameters.

The inventors also recognize that the technical systems can be further improved by providing for a selection of a best solver under given time constraints. For example, in the industrial sector, resource allocation is a critical task to run in real time and suffers from the challenge that resource allocation problems typically include a large number of unknowns and constraints. In this application, and in many other artificial intelligence (AI) applications, it can be provided that the solver find a solution in the least amount of time for a given accuracy or that for a specific budget of time it returns the most accurate solution.

In an embodiment, the present invention addresses the problems of HPS and AS by taking advantage of previously-solved problems. In particular, the quality of particular solvers and hyperparameter configurations for a particular instance of a MILP problem as predicted based on prior knowledge of similar past examples.

Embodiments of the present invention therefore require that there exist or be provided more than just a single algorithm with a single configuration of hyperparameters. However, as used herein, HPS and AS cover different methods for arriving at an algorithm with a set of hyperparameters for a given MILP problem. For example, it is possible to select from a set of algorithms which each have their own configuration of hyperparameters. It is also possible to interface with all available algorithms to build a selection algorithm for selecting among the available algorithms, and for each algorithm select a hyperparameter configuration. It is further possible to create multiple algorithms from a single algorithm and its hyperparameter configuration (e.g., algorithm A1=algorithm A with a first hyperparameter configuration, algorithm A2=algorithm A with a second hyperparameter configuration, and so on). In this case, the hyperparameter configurations can be preselected. It is even further possible, within the meaning of performing HPS and AS herein, to find or select a hyperparameter configuration and then select from a set of algorithms based on the predicted performance of the hyperparameter configurations therein, or to select among different hyperparameter configurations for a given algorithm.

In an embodiment, a method for hyperparameter selection (HPS) and algorithm selection (AS) for mixed integer linear programming (MILP) problems is provided, the method comprising:
collecting MILP problems and performances of associated solvers for optimizing the MILP problems;
mapping each of the MILP problems into a graph having nodes each comprising one of the variables and constraints of the MILP problems;
generating raw features of the nodes of the graphs;
learning, for each of the graphs, a representation of the nodes of the graphs global to the MILP problems using the raw features;
training a machine learning model using the learned representations; and
using the trained learning model to select one of the solvers for a new MILP problem.

The method can further provide that the graphs are bipartite graphs mapping the variables on one side to the constraints on the other side.

The method can further provide that the raw features of the nodes are generated by navigating the graphs and include one hop statistics on basic features.

The method can further provide that the learned representations are generated from a combination of embeddings derived for each of the graphs using the raw features and an embedding function.

The method can further provide that the embeddings are derived using summary statistics of all of the nodes for each of the MILP problems, and by generating node prototypes using k-means clustering and associating to each of the graphs a sum over the nodes of a normalized distance to the node prototypes.

The method can further provide that the raw features of the nodes are used to derive two additional embeddings for each of the MILP problems by taking an average of the raw features over all of the nodes for each of the respective graphs, and by generating node prototypes from the embeddings of the nodes using k-means clustering and associating to each of the nodes of the graphs a new embedding defined by a vector of a normalized distance to the node prototypes such that, for each of the graphs, the new embedding is generated from the embeddings of the node using respective values of mean, median and standard deviation for the respective nodes.

The method can further provide that a further embedding for each of the MILP problems is derived by counting graphlets or motifs in each one of the respective graphs.

The method can further provide that the representations of the nodes are learned using a neural network as an embedding function and using neural network message passing to determine values for weights in the neural network.

The method can further provide that the new MILP problem is mapped into a graph and raw features of the nodes are generated on the graph and applied as input to the trained learned learning model which provides as output a prediction of the best solver for the new MILP problem.

The method can further provide that the MILP problems are general problems cast as Boolean satisfiability problems and include one of the following problems: integrated circuit design, combinatorial equivalence checking, model checking, planning in artificial intelligence and haplotyping in bioinformatics.

The method can further provide that the MILP problems are vehicle routing problems in which the variables are the allocation of vehicles to a single route and the constraints are an amount of vehicles and customer requirements, the method further comprising routing the vehicles based on the output of the selected solver.

The method can further provide that the MILP problems include personnel planning problems in which the variables are an allocation of personnel having particular skills for particular tasks and the constraints link to a cost of the personnel, the method further comprising scheduling the personnel based on the output of the selected solver.

The method can further provide that the MILP problems include job planning problems in which the variables are an allocation of robots having particular functions for particular manufacturing jobs and the constraints link to a cost of operating the robots, the method further comprising manufacturing a product using the robots scheduled and functioning according to the output of the selected solver.

According to another embodiment, a computer system is provided for hyperparameter selection (HPS) and algorithm selection (AS) for mixed integer linear programming (MILP) problems, the system comprising one or more computer processors which, alone or in combination, are configured to execute a method comprising:
collecting MILP problems and performances of associated solvers for optimizing the MILP problems;
mapping each of the MILP problems into a graph having nodes each comprising one of the variables and constraints of the MILP problems;
generating raw features of the nodes of the graphs;
learning, for each of the graphs, a representation of the nodes of the graphs global to the MILP problems using the raw features;
training a machine learning model using the learned representations; and
using the trained learning model to select one of the solvers for a new MILP problem

According to a further embodiment, provided is a tangible, non-transitory computer-readable medium having instructions thereon, which executed by one or more processes, provide for execution of a method for hyperparameter selection (HPS) and algorithm selection (AS) for mixed integer linear programming (MILP) problems, the method comprising:
collecting MILP problems and performances of associated solvers for optimizing the MILP problems;
mapping each of the MILP problems into a graph having nodes each comprising one of the variables and constraints of the MILP problems;
generating raw features of the nodes of the graphs;
learning, for each of the graphs, a representation of the nodes of the graphs global to the MILP problems using the raw features;
training a machine learning model using the learned representations; and
using the trained learning model to select one of the solvers for a new MILP problem.

In the following, a set of MILP problems {Pᵢ} (set of problems P of size=N, Pᵢ₌₁^{N}) are considered that represent a history of problems, each problem having values for an optimization (e.g., a minimization problem (minₓ2x, such that x≥1, with the values 2, 1≥1 defining the problem as coefficients of the minimization problem)). For each instance, it is expected to have one or more configurations of algorithm and hyperparameters that give the best performances. A new MILP problem P (having problem values comprising a cost function and constraints) is then considered for which it is desired to find an optimal algorithm and hyperparameter configuration that provide the best solution in terms of computation time and/or accuracy of solution within a fixed time budget.

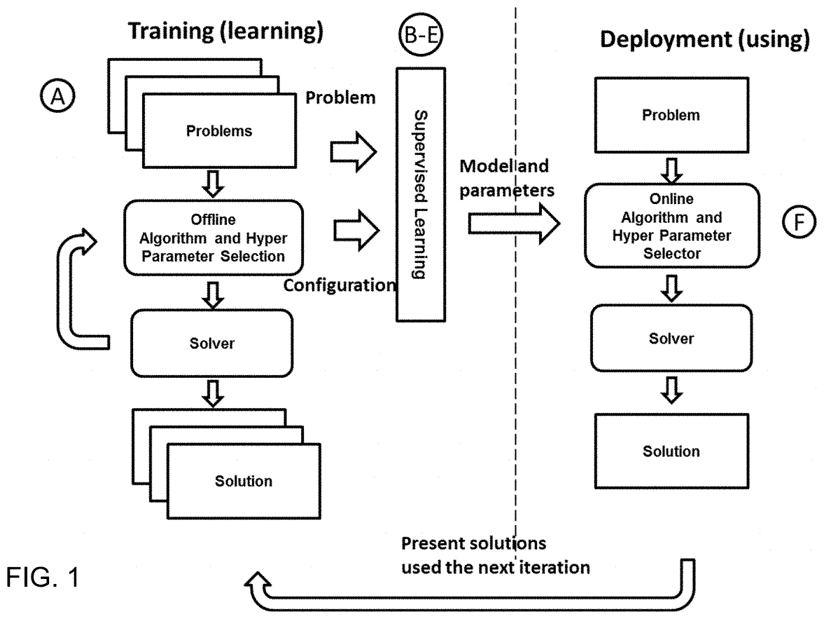

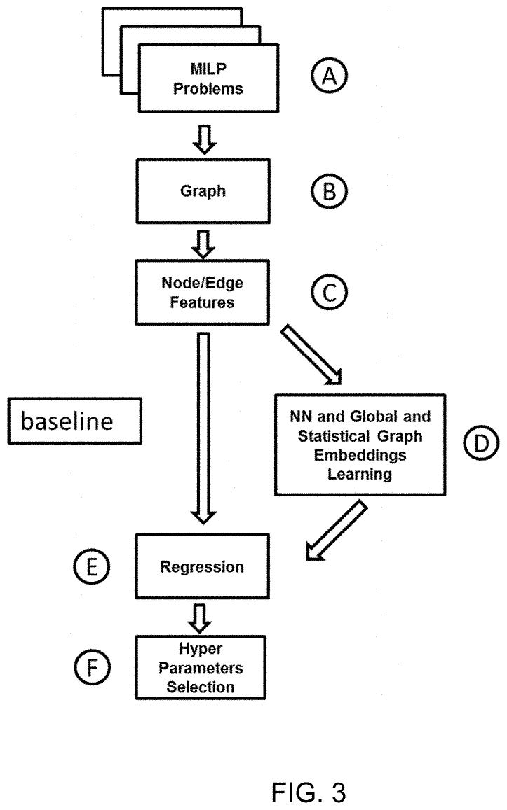

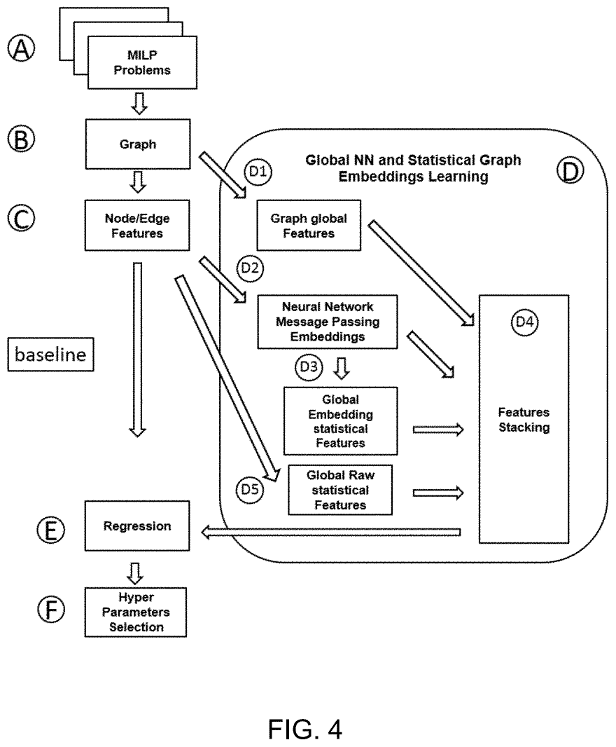

FIG. 1 schematically illustrates this approach according to an embodiment of the present invention. As illustrated therein, the approach includes two phases: a training (learning) phase including steps A-E which can be performed offline and a deployment (using) phase including step F which is preferably done online (see also FIGS. 3 and 4). Step A includes collecting a history of MILP problems. Step B includes mapping of the MILP problems to a graph including nodes. Step C includes extracting basic features of the nodes. Step D includes generating embeddings as high level features. Step E includes regression on the performance, or in other words, the learning of a regression model from historical data that will then be used in the deployment (using) phase. There, in step F, the regression model is used for HPS and AS. Also shown in FIG. 1 is the offline algorithm and hyperparameter selection for selecting a solver which provides optimal solutions to the respective MILP problems collected in step A. Preferably, a tool referred to herein as oracle is used for this offline training. In an embodiment, the oracle performs a brute force approach, taking as long as necessary to arrive at the optimal solutions. Alternatively or additionally, other methods of offline HPS and AS could also be used for the training, and/or the training could be based on the use of the solvers in the previous instances.

In order to generate an accurate representation of the MILP problems, both from the history and from the new instance, a representation is generated that is based on the following aspects:
1. The representation is independent of the use of the representation itself. Embodiments of the present invention provide the representation of MILP problems by mapping the MILP problems into graphs. The graphs can be used independently for other purposes. Not linking the representation or a property thereof to its use avoids computational inefficiencies. Regardless of the use, the graphs advantageously allow to perform further computations on the MILP problems.
2. The representation captures the structure of the problem and the relationship among its components.
3. The representation has a form that is common to all instances which can be compared in order to discriminate among different problems.

The representation is based on mapping the original MILP problem into a graph. Each MILP problem is converted into a graph. For each graph, a representation is learned that discriminates the problems. An embedding function is a second mapping from the graph space to a vector space, that is, a space equipped with a distance function and operators (sum) that allows comparison of problems.

The first step is to build a graph that can capture any MILP problem. The general form of a MILP problem is as follows:

$${min}_{x \text{:} {x}_{I} ∈ N} {c}^{T} x \\ subject to \text{:} \\ {A}_{0} x = {b}_{0} \\ {A}_{1} x \leq {b}_{1} \qquad equation ( 1 )$$

where c is the cost coefficient; A is the problem matrix defining the linear combination of the variables; A=(A₀, A₁) defines the constraints; b is the vector of the coefficient that the equation shall equate (b₀) or be less than or equal to (b₁); T is the transpose operator which transforms a column vector into its row version, or from R^{nx1} to R^{1xn}, where R is the set of real values; N is the set of integers; x₁ are the integer variables, I is the set of the index of variables that need to be integer. c^{T}x represents the inner product of the vectors of the size (Σᵢ₌₁ⁿ cᵢxᵢ), or the cost or objective of the problem.

While equation (1) captures the general MILP problem, it is rewritten according to an embodiment of the present invention in the following compact form:

$${min}_{x \text{:} {x}_{1} ∈ N} {x}_{0} \\ subject to \text{:} \\ {A}_{0} x = 0 \\ {A}_{1} x \leq 0 \qquad equation ( 2 )$$

Based on representation, the following information is generated:
1) A=(A₀^{T}, A₁^{T})^{T}, b=(b₀^{T}, b₁^{T})^{T}
2) e={eᵢ={−2, −1, 0, 1, 2}}. The vector that indicates the type of constraints (e.g., <→−2, ≤→−1, =→0, ≥→1, >→2) is defined for each constraint.
3) d ∈ {0, 1, 2}ⁿ represents the type of variable, 0: real, 1: integer, 2: binary.

The problem matrix and variable vector are then defined as follows:

$$\begin{matrix}{A}^{′} = [ \begin{matrix}0 & A & b \\ 1 & {c}^{T} & 0\end{matrix} ] ∈ {R}^{m + 1 \times n + 2} & equation ( 3 ) \\ {x}^{′} = [ \begin{matrix}{x}_{0} \\ x \\ {x}_{n + 1}\end{matrix} ] ∈ {R}^{n + 2} & equation ( 4 )\end{matrix}$$

where x_{{n+1}}=1. The new problem has n+2 variables and m+1 constraints, where n and m are the original number of variables and constraints, respectively. The original MILP problem can now be mapped in the following triplet:

X=(A, e, d)

where A ∈ R^{m×n}, b ∈ R^{m}, e ∈ {−2, −1, 0, 1, 2}^{m}, d ∈ {0, 1, 2}ⁿ, and it has been redefined that m=m+1, n=n+2.

Associated with X there is a class of equivalent problems defined by the permutation on the variable and on the constraints as follows

X′=(PₘAPₙ, Pₘe, Pₙ^{T} d)=π(X)

and there are n!m! of such equivalent problems.

MILP problems are specified in mathematical terms as a set of linear functions. Each term of the linear functions can be permuted for the commutative property of real numbers and the equation can be moved freely to provide different formulizations of the same problem. Further, each equation can be multiplied for a positive value and remain the same problem. This is represented by the permutation function π(X). A permutation is an ordering of a sequence of values in a particular way. For example, 2, 1, 3 is a permutation equal to the switching of the first two values of the sequence of values 1, 2, 3.

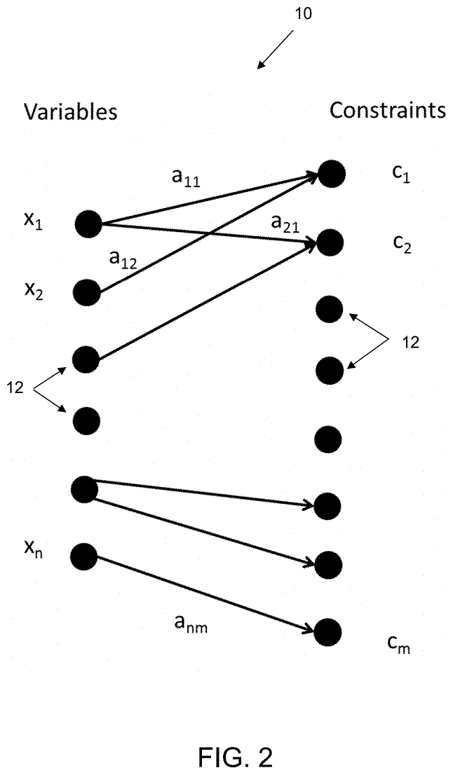

As illustrated in FIG. 2, based on X, a bipartite graph 10 is built with the nodes 12 being the variables and the constraints, and with the edges being the relationships between the variables and the constraints derived by the problem matrix A. The arrows aₙₘ indicate whether a variable xₙ participates in a constraint cₘ. If aₙₘ is not zero, then the m^{th} constraint is a function of the n^{th} variable. The value of aₙₘ is given by the problem matrix in equation (3). In this formulation, the problem matrix A now becomes an adjacency matrix, whose rows are associated with the constraints and whose columns are associated with the variables. The basic features (attributes) of the variable nodes are the domain (real, integer, binary); the basic features (attributes) of the constraint nodes are the upper and lower bound value and sign as defined by e. The bounds are captured in both A and e.

Referring now also to FIGS. 1, 3 and 4 illustrating the sequence B-E for the representation learning according to embodiments of the present invention, after all problems have been collected in step A and mapped into the graph 10 in step B, an embedding function is learned to further map the problems into a vector space, which is also referred to as representation learning. Each node 12 (variable or constraints) of the graph 10 is associated with some raw features in a step C. These raw features are computed by navigating the graph 10 can include the one hop statistics (mean, max, min, median, standard deviation) on the basic features (e.g., bound type, variable type positive- or negative-valued), the number of neighbors and their statistics.

The raw features of the nodes 12, as well as the graph structure, are then used to learn the embedding function in step D. For example, a neural network is used as the embedding function. In this example, learning the embedding function entails finding appropriate values for the weights in the neural network in a step D2. A neural network message passing algorithm is one example of an approach to perform this learning. Preferably, this is performed using the method embedding propagation (EP) discussed by Garcia-Duran, Alberto et al., “Learning Graph Representations with Embedding Propagation,” 31st Conference on Neural Information Processing Systems, arXiv:1720.03059 (2017), which is hereby incorporated by reference herein.

A general message passing can be defined:

for t=1: T;

for i=1: n;

h(i)^{t+1}=Σⱼ^{N(i)} H(h(j)^{t});

m(i)^{t+1}=M(m(i)^{t}, h(i)^{t+1});

where H, M are the neural network, N(i) are the neighbors of i and h(i)^{t+1} and m(i)^{t} are the messages that are propagated.

A further step can be used to collect information on the last by:

y=Σᵢ₌₁ⁿR(m(i)^{T})

where R is another neural network, and, in this instance, T represents the last step (as opposed to the transpose operator T used above).

After learning, the embedding function gives a vector representation for each node 12 in all graphs 10, and therefore gives a vector representation for each variable and constraint in all MILP problems.

These node representations are used to derive embeddings for the entire problems in two ways in step D3. First, summary statistics (e.g., mean, median and standard deviation) are taken of all nodes for each MILP problem to arrive at a first embedding for each problem. The summary statistics can further include, for example, the number of neighbors, weights connecting to the neighbors and weights of the neighbors. Second, node prototypes are generated using k-means clustering and, for each graph, the sum over the nodes of a normalized distance (probability) is associated to the node prototypes as a second embedding. These two embeddings are stacked to arrive at the complete embedding of each MILP problem.

The following is an example of pseudocode generating the prototypes and determining the normalized distance to the node prototypes:

```
given:
E = e(i, j), where e (i, j) are embeddings at the node level for each graph i
for each node j;
returns:
p(i, k): the pseudo probability of a prototype k on the graph I;
do:
Q = kmeans(E, K) where Q = {qₖ};
for k = 1:K
  d(i, j, k) = dist(qₖ, e(i, j));
  $p ( i , k ) = \frac{{\sum }_{j} d ( i , j , k )}{{\sum }_{j , {k}^{′}} d ( i , j , {k}^{′} )} ;$
return p(i, k).
```

where K is the number of prototypes, k and k′ are indexes and qₖ is a vector.

Further, the node raw features are used to create two additional embeddings for each MILP problem. In this example, a simple average is taken over all nodes in the MILP problem as a third embedding. Then, to generate a fourth embedding, the prototype-based approach is used on the raw feature in a step D5.

A fifth embedding of the graph is created by counting its higher-order substructures, sometimes referred to as graphlets or motifs. For example, the number of triangles in the graph structure can be counted. This can be done in step D1.

Thus, in summary, in step D1, global features of the graphs are calculated, for example, by counting for each of the graphs the numbers of pairs, triplets, quadruplets, etc. Raw features of the nodes are used as input to steps D2-D4. In step D2, the neural network message passing, for example using EP, is performed to determine the embedding function used in step D3 for deriving the embeddings. In step D4, the embeddings are concatenated into one representation as a vector used for regression in step E. The stacking in step D4 therefore is a juxtaposition of the vectors of the embeddings to create a longer vector as a union of the different vectors of the embeddings. This is advantageous for the regression by providing a complete view of the data and capturing small details rather than using separate features which do not provide a complete view.

After finding the representation of each MILP problem, a machine learning model is trained in step E to predict the performance of a solver and specific configuration of hyperparameters for a particular MILP problem. The history of MILP problems {Pᵢ} is used for this training. As new problems are considered, the model can be updated based on performance of the predictions. However, the model can always be used for new problems without having to be updated.

Then, in step F, this model is used to solve the HPS and AS problem for a new MILP problem P. The new MILP problem P is mapped to a graph and the node raw features of the graph are determined as in steps C and D1 with the training data discussed above. In particular, the performance of all known solvers and hyperparameter configurations are predicted on the new MILP problem P. The solver with the best predicted performance is used for the new MILP problem P. For example, a general regressor or a regressor using a nearest neighbor approach could be used for the prediction to determine which of the old problems is closest to the new MILP problem P. By using the previously learned neural network (learned offline), in an online mode for the new MILP problem, there is no need to perform learning on the new MILP problem P, thereby saving time and computational costs. In practice, these predictions are very fast and the optimization can be performed in real time or near-real time. Thus, compared to the state of the art where solutions to many MILP problems cannot be obtained in a predictable timeframe and require minutes to hours to solve, the present invention can be used to not only find a faster solution, but to resolve multiple different scenarios for MILP problems in a matter of seconds. In addition to providing for increased flexibility, this advantageously allows for use of the method with MILP problems of various complexities, while taking only a small fraction of the time previously required and using far less computational resources to reach a solution.

The trained learned learning model is therefore both: 1) the function that maps from the graphs to the embeddings; and 2) the function that from the embedding generates the optimal configuration or selects the optimal algorithm.

The method according to embodiments of the present invention therefore integrates global and learned embedding using neural networks with statistical embeddings, and, in addition to the improvements discussed above, has also been found to improve accuracy. Notably, as discussed further below, the method was able to achieve accuracy within 13.6% of the maximum gain defined by the oracle tool of the offline optimization, while the other baseline methods lost around 30% in the selected dataset. As noted above, the brute force HPS and AS optimization would require a huge and unreasonable amount of computational resources for real time or near-real time use.

Embodiments of the present invention can be implemented to provide the above-described improvements in various industrial applications in which various problems can be defined as MILP problems.

According to an embodiment, the present invention can be used for chipset manufacturing and for fabricating integrated circuits. In particular, chipset manufacturing generates MILP problems with large computation time requirements. Fabricated integrated circuits need to be checked for defects. One of the most widely used approaches to check integrated circuits is by automatic test-pattern generation (ATPG) and single stuck-at fault model (SSF), where each connection is associated with a Boolean variable (faulty/not faulty, equivalently stuck-at/not stuck-at). ATPG is performed by detecting whether such assignments are possible. Two copies are constructed of the circuit, one with the correct connection and the other with the faulty connection. The fault can be detected if there is any input from which the two circuits give different output. In this application, the variables are the possible binary input and the constraints are generated by the verification of the equality or inequality of the output of the two circuits.

The application of Boolean satisfiability (SAT) in ATPG is discussed further in Marques-Silva, J., “Practical Applications of Boolean Satisfiability,” Workshop on Discrete Event Systems (WODES'08), Sweden (May 2008), which is hereby incorporated by reference herein. This publication also describes other industrial applications which generate MILP problems to which embodiments of the present invention can be applied. For example, combinational equivalence checking, model checking, planning in artificial intelligence and haplotyping in bioinformatics. In these embodiments, the general problems are cast as SAT problems. Further embodiments of the present invention can be used for HPS and AS in solving other SAT problems or general problems cast as SAT problems, in which solutions to such problems provide for optimizing an objective or cost function in, for example, automated reasoning, computer-aided design, computer-aided manufacturing, machine vision, database, robotics, integrated circuit design and computer architecture design. There are different solvers available for SAT problems, such as general MILP solvers like GUROBI, GNU Linear Programming Kit (GLPK), Solving Constraint Integer Programs (SCIP) and specialized solvers such as GLUCOSE, MINISAT, LINGELING, etc. The embodiments for SAT applications provide to understand as quickly as possible the solution to the problem of satisfiability, with gains provided from hours to seconds according to embodiments of the present invention, and corresponding increases in computational efficiency.

According to an embodiment, the present invention can be used for resource allocation in an industrial environment, for example, for the scheduling of personnel or manufacturing jobs. The jobs and the personnel need to be rescheduled continually, in real time, to ensure optimal efficiency. As mentioned above, brute force approaches could not work in such an application, while in contrast the present invention can be used quicker and with greater accuracy than other approaches. In job scheduling for industrial manufactory, the jobs are the automatic industrial processing of the raw material into the final product. In this context, the jobs are associated with completion time and sequence of manufacturing. The variables are the jobs, the times of processing and the resources that process the single object. The constraints are the time that it takes to process an object at a specific station, the cost of the use of a specific resource (in time, energy and economical cost) and the output rate of the whole system.

According to an embodiment, the present invention can be used for resource allocation in distributed computer systems to allocate computational resources in an optimal way leading to reduction of computation time and power, communication, downtime, energy and costs. The ability to solve increasingly complex problems allow to further these reductions. In cloud computing systems, the method is applicable for improving performance of job allocation to constrained resources like memory, CPUs, etc. In this application, the variables are the computational jobs to be executed and the constraints are the hardware and computational resources available and the allocated budget for each job.

According to an embodiment, the present invention can be used for transportation and logistics. The vehicle routing problem (VRP) and travel salesman problem (TSP) are examples of Integer Linear Programming (ILP) problems, in which some or all variables are restricted to be integer, as with MILP problems. MILP problems are ILP problems in which some of the variables can be continuous. For automatic vehicle routing, the variables are the allocation of vehicles to a single route and the constraints are the number of vehicles and customer requirements. The road network can be used for deriving distances between destinations. The use of the present invention to perform HPS and AS in this setting, for example, can minimize the global transportation cost in terms of distance, fuel, emission, consumption, time or otherwise and enables to make routing decisions quicker and with greater accuracy than existing methods. Typically, the goal of VRP is to minimize one or more costs, while having solution as quickly as possible. In other embodiments, specific for manufacturing, for example, the problem of scheduling of the production line, the optimal visitation of the robots to all required stations can be solved while meeting the demands of the stations and the capacity of the robots.

According to an embodiment, the present invention can be used for airport personnel planning, airplane departure and arrival scheduling are MILP problems where continuous optimization results in a number of efficiencies in terms of travel and operational costs, delays, fuel time, etc. The variables for personnel problems are shifts of particular personnel having particular skills for particular tasks. The constraints are related to the task to be performed (number of personnel for profile, combination of possible profiles, task duration for each skill), relation among tasks (e.g., a task needs other to be completed before) and constraints link to personnel (as max number of hours of work, pause, fairness in shifts, vacations, etc.). Cost can be linked in terms of the personnel cost, time of completion of tasks, cost of alternative tasks, etc. In airplane scheduling, the variables are which airplane is taking off/landing at a specific timeslot depending on constraints such as priority in booking, fuel level, weather condition, availability at arrival, cost of cancellation, etc. The cost is linked to flight operation (minimum single and overall delay) or cost for not allocating flights, or risk of combinations and future weather forecasts. Different personnel, routing and scheduling changes can thereby be implemented continuously and with greater accuracy than existing methods using HPS and AS in this setting according to an embodiment of the present invention.

According to an embodiment, the present invention can be used for digital health for the scheduling of personnel, patient visits, medical examinations, drug planning for optimal treatment, and personnel utilization, or for scheduling of medical instrument resources such as MRI equipment, which considers personnel time, machine maintenance and risk of downtime.

Improvements and advantages according to embodiments of the present invention include:
4. Mapping of MILP problem into a graph structure where the objective or cost function and constraints (inequality and equality) are coherently mapped, in a form of a bipartite graph.
5. Learning of representations for MILP problems using the bipartite graphs, in which, advantageously, the embeddings are generated global to all problems by considering all of the corresponding graphs, so that instances that are closer have embeddings that are close in the embedding space.
6. Use of node and graph level features, including higher-order structures, such as the graphlets, to learn representations used for the training of the machine learning model and prediction in HPS and AS using the results of the machine learning.
7. Learning representations based on an embedding function.
8. Integration of statistical and embedding features of the MILP instances.
9. Use of the learned representation for regression/classification (prediction of runtime/accuracy) on MILP problems for HPS and AS.
10. Integration of the oracle tool in offline learning and prediction for fast online hyper parameter configuration.
11. Faster than existing tools (e.g. irace/ParamILS in which it would take days to find optimal configurations for all instances) that allow for online HPS and AS.
12. Better regression accuracy compared to state of art regression approaches (e.g. raw feature). For example, raw feature was found to degrade 8% in regression accuracy in the evaluated dataset. Moreover, others tools are much slower in the selection of a solver configuration for new instances.

According to an embodiment, a method for HPS and AS comprising the steps of (with reference to FIGS. 1, 3 and 4):
Step A: Collecting MILP problems and associated performance (time, accuracy or accuracy per unit of time) of the configurations of the algorithms for the known solvers to the respective problem instances as the machine learning training data. According to an embodiment, this is provided as the output of the oracle tool or the irace/ParamILS tool. The configurations can also be tested on other instances for which they are not optimal for the training as well.
Step B: Mapping each of the MILP problems into a graph.
Step C: Generating basic raw features on the graphs.
Step D: Learning a representation in globally learned for all of the MILP problems using the graphs.
Step E: Training a machine learning based on the representation to predict performance based on the training data.
Step F: Mapping new MILP instances into a graph, and then extracting the embedding, and selecting the most appropriate solver configuration using the trained machine learning model.

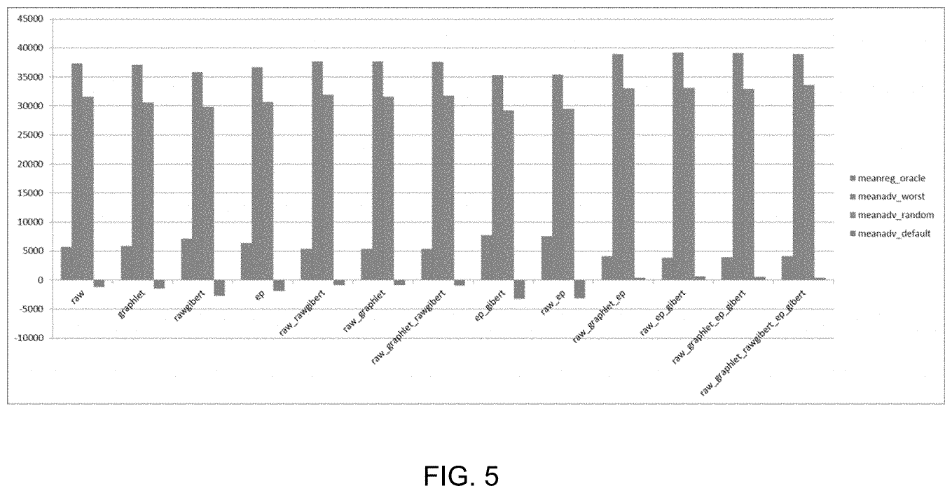

FIG. 5 shows the performance as mean difference of runtime between the method selected based on the (minimum) runtime using the learned model according to embodiments of the present invention and other approaches (specifically: oracle, worst, random, default or average). The methods shown in FIG. 5 and Table 1 below according to embodiments provide for the representation to consist of different embeddings. The method raw includes a representation learned based on the raw node features. The method graphlet includes a representation learned based on the graphlets, The method ep includes a representation learned using EP. Other methods include a representation generated from a combinations of the different learned embeddings. As used herein, “gibert” represents the statistic/prototype shown as global embeddings statistical features of step D3; “rawgibert” represents an application of the statistical features on the raw features (as opposed to on the embeddings) from step D3, or the raw embeddings statistical features; and “graphlets” represent the graph global features.

FIG. 5 shows for each embedding method the following information:
1) meanreg_oracle (left-most column/bar for each method in FIG. 5): the accuracy difference between the method prediction and the oracle tool (best) method (i.e. the configuration that gives the best accuracy), where a lower value closer to zero indicates better performance.
2) meanadv_worst (second column/bar from left for each method in FIG. 5): the accuracy difference compared to the worst prediction possible, where a higher value is better to have the maximum advantage to the worst selector.
3) meanadv_random (third column/bar from left for each method in FIG. 5): the difference when a configuration is selected at random, where a higher value is better to be better than random.
4) meanadv_default (fourth and last column/bar from left for each method in FIG. 5): the difference to the default configuration, which is the configuration selected as the one that performs average, where a higher value is also better. Advantageously, it can be seen that some of the methods according to embodiments of the present invention, in particular those including combinations of embeddings, perform even better than the average configuration despite being significantly faster and more computationally efficient.

The following tables show performance of embodiments of the present invention, where mean average error (mae) and mean square error (mse) are shown for the different methods in Table 1 as the measure of accuracy between the predicted and test values for the machine learning (training set used to train the model vs. the test set), where a smaller value is better. It can be seen that all method performed well, especially ep and those involving ep, providing errors of less than 5%. Table 2 shows ranking performances. When using regression, the configuration are ordered based on the expected runtime. Low rank is given to the configuration with lower predicted runtime. With respect to an instance, there is also the real rank, which is based on the runtime on the specific instance. The first ranking will be given to the best configuration. In Table 2 rank_reg is the mean difference of rank between the best predicted configuration with respect to the actual best (which has the first overall rank). For example, if the best predicted configuration in reality is the tenth best when executed, then rank_reg=10 (lower values are better). In Table 2 rank_true this is the same analysis against the true best configuration. The best configuration will have a predicted runtime value that will be ranked with the other configurations. If it has rank 10, this means that the predictor predicts the configuration is at the tenth position (again, lower values are better). Table 3 shows regret vs. the oracle tool, or in other words, the regret of not using the oracle tool as the sum of all runtime difference on all of the instances, where again lower values are better. Table 4 shows the performance vs. the oracle tool. Negative values in Table 4 indicate that the respective method performs worse than baseline, referred to as negative transfer. In contrast, however, different embodiments of the present invention can be seen to have positive transfer and also provide the other advantages discussed herein compared to standard or baseline approaches.

TABLE 1

| Method | mae | % of mae | mse | % of mse |
|---|---|---|---|---|
| raw | 181.6657 | 15% | 345.9737 | 8% |
| graphlet | 244.6409 | 55% | 437.2762 | 36% |
| rawgibert | 195.9194 | 24% | 377.1457 | 17% |
| ep | 166.7356 | 5% | 337.5671 | 5% |
| raw_rawgibert | 189.7668 | 20% | 353.1779 | 10% |
| raw_graphlet | 186.1018 | 18% | 349.9295 | 9% |
| raw_graphlet_rawgibert | 191.8107 | 21% | 353.8555 | 10% |
| ep_gibert | 183.0089 | 16% | 463.4134 | 44% |
| raw_ep | 159.1245 | 1% | 322.6884 | 0% |
| raw_graphlet_ep | 158.3208 | 0% | 321.378 | 0% |
| raw_ep_gibert | 160.3422 | 1% | 331.2652 | 3% |
| raw_graphlet_ep_gibert | 159.3287 | 1% | 327.9529 | 2% |
| raw_graphlet_rawgibert_ep_gibert | 161.9137 | 2% | 328.8608 | 2% |

### Ranking Performances:

TABLE 2

| | | rank | | |
|---|---|---|---|---|
| Method | rank_reg | degradation | rank_true | |
| raw | 43.38667 | 25% | 73.786667 | 26% |
| graphlet | 46.52667 | 34% | 88.46 | 51% |
| rawgibert | 79.06667 | 128% | 109.52667 | 87% |
| ep | 47.92667 | 38% | 60.013333 | 2% |
| raw_rawgibert | 38.64667 | 12% | 80.586667 | 37% |
| raw_graphlet | 40.82667 | 18% | 75.48 | 29% |
| raw_graphlet_rawgibert | 48.86 | 41% | 76.52 | 31% |
| ep_gibert | 61.84667 | 79% | 68.086667 | 16% |
| raw_ep | 51.82 | 50% | 62.173333 | 6% |
| raw_graphlet_ep | 40.04 | 16% | 58.62 | 0% |
| raw_ep_gibert | 36.82667 | 6% | 61.713333 | 5% |
| raw_graphlet_ep_gibert | 34.60667 | 0% | 62.766667 | 7% |
| raw_graphlet_rawgibert_ep_gibert | 39.54667 | 14% | 66.533333 | 13% |

### Regret vs Oracle:

TABLE 3

| Method | meanreg_oracle | regret degradation |
|---|---|---|
| raw | 5711.66 | 47% |
| graphlet | 5909.16 | 52% |
| rawgibert | 7185.24 | 85% |
| ep | 6391.42 | 65% |
| raw_rawgibert | 5369.54 | 38% |
| raw_graphlet | 5336.52 | 38% |
| raw_graphlet_rawgibert | 5407.3 | 39% |
| ep_gibert | 7740.88 | 100% |
| raw_ep | 7597.57 | 96% |
| raw_graphlet_ep | 4073.6 | 5% |
| raw_ep_gibert | 3878.67 | 0% |
| raw_graphlet_ep_gibert | 3948.06 | 2% |
| raw_graphlet_rawgibert_ep_gibert | 4071.66 | 5% |

### Performance vs Oracle

TABLE 4

| Method | per_of_oracle |
|---|---|
| raw | −27.2% |
| graphlet | −31.6% |
| rawgibert | −60.0% |
| ep | −42.3% |
| raw_rawgibert | −19.6% |
| raw_graphlet | −18.8% |
| raw_graphlet_rawgibert | −20.4% |
| ep_gibert | −72.4% |
| raw_ep | −69.2% |
| raw_graphlet_ep | 9.3% |
| raw_ep_gibert | 13.6% |
| raw_graphlet_ep_gibert | 12.1% |
| raw_graphlet_rawgibert_ep_gibert | 9.3% |

The foregoing information in FIG. 5 and Tables 1-4 showing the advantages and improvements for the different embodiments of the present invention was obtained by testing prototypes on publicly available datasets from the Mixed Integer Programming LIBrary (MIPLIB) 2010.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for hyperparameter selection (HPS) and algorithm selection (AS) for mixed integer linear programming (MILP) problems, the method comprising:
collecting MILP problems and performances of associated solvers for optimizing the MILP problems;
mapping each of the MILP problems into a graph having nodes each comprising one of the variables and constraints of the MILP problems;
generating raw features of the nodes of the graphs;
learning, for each of the graphs, a representation of the nodes of the graphs global to the MILP problems using the raw features;
training a machine learning model using the learned representations; and
using the trained learning model to select one of the solvers for a new MILP problem.

2. The method according to claim 1, wherein the graphs are bipartite graphs mapping the variables on one side to the constraints on the other side.

3. The method according to claim 2, wherein the raw features of the nodes are generated by navigating the graphs and include one hop statistics on basic features.

4. The method according to claim 1, wherein the learned representations are generated from a combination of embeddings derived for each of the graphs using the raw features and an embedding function.

5. The method according to claim 4, wherein the embeddings are derived using summary statistics of all of the nodes for each of the MILP problems, and by generating node prototypes using k-means clustering and associating to each of the graphs a sum over the nodes of a normalized distance to the node prototypes.

6. The method according to claim 5, wherein the raw features of the nodes are used to derive two additional embeddings for each of the MILP problems by taking an average of the raw features over all of the nodes for each of the respective graphs, and by generating node prototypes from the embeddings of the nodes using k-means clustering and associating to each of the nodes of the graphs a new embedding defined by a vector of a normalized distance to the node prototypes such that, for each of the graphs, the new embedding is generated from the embeddings of the node using respective values of mean, median and standard deviation for the respective nodes.

7. The method according to claim 6, wherein a further embedding for each of the MILP problems is derived by counting graphlets or motifs in each one of the respective graphs.

8. The method according to claim 1, wherein the representations of the nodes are learned using a neural network as an embedding function and using neural network message passing to determine values for weights in the neural network.

9. The method according to claim 1, wherein the new MILP problem is mapped into a graph and raw features of the nodes are generated on the graph and applied as input to the trained learned learning model which provides as output a prediction of the best solver for the new MILP problem.

10. The method according to claim 1, wherein the MILP problems are general problems cast as Boolean satisfiability problems and include one of the following problems: integrated circuit design, combinatorial equivalence checking, model checking, planning in artificial intelligence and haplotyping in bioinformatics.

11. The method according to claim 1, wherein the MILP problems are vehicle routing problems in which the variables are the allocation of vehicles to a single route and the constraints are an amount of vehicles and customer requirements, the method further comprising routing the vehicles based on the output of the selected solver.

12. The method according to claim 1, wherein the MILP problems include personnel planning problems in which the variables are an allocation of personnel having particular skills for particular tasks and the constraints link to a cost of the personnel, the method further comprising scheduling the personnel based on the output of the selected solver.

13. The method according to claim 1, wherein the MILP problems include job planning problems in which the variables are an allocation of robots having particular functions for particular manufacturing jobs and the constraints link to a cost of operating the robots, the method further comprising manufacturing a product using the robots scheduled and functioning according to the output of the selected solver.

14. A computer system for hyperparameter selection (HPS) and algorithm selection (AS) for mixed integer linear programming (MILP) problems, the system comprising one or more computer processors which, alone or in combination, are configured to execute a method comprising:
collecting MILP problems and performances of associated solvers for optimizing the MILP problems;
mapping each of the MILP problems into a graph having nodes each comprising one of the variables and constraints of the MILP problems;
generating raw features of the nodes of the graphs;
learning, for each of the graphs, a representation of the nodes of the graphs global to the MILP problems using the raw features;
training a machine learning model using the learned representations; and
using the trained learning model to select one of the solvers for a new MILP problem

15. A tangible, non-transitory computer-readable medium having instructions thereon, which executed by one or more processes, provide for execution of a method for hyperparameter selection (HPS) and algorithm selection (AS) for mixed integer linear programming (MILP) problems, the method comprising:
collecting MILP problems and performances of associated solvers for optimizing the MILP problems;
mapping each of the MILP problems into a graph having nodes each comprising one of the variables and constraints of the MILP problems;
generating raw features of the nodes of the graphs;
learning, for each of the graphs, a representation of the nodes of the graphs global to the MILP problems using the raw features;
training a machine learning model using the learned representations; and
using the trained learning model to select one of the solvers for a new MILP problem.
